(19) United States
(12) Patent Application Publication
(10) Pub. No.: US 2009/0247709 A1
(43) Pub. Date: Oct. 1, 2009

(54) DIAMINE POLYMER AND RESIN COMPOSITION THEREOF

(75) Inventors: Hatsuo Ishida, Shaker Heights, OH (US); Masanori Nakamura, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignees: CASE WESTERN RESERVE UNIVERSITY, Cleveland, OH (US); SEKISUI CHEMICAL CO., LTD., Osaka-shi (JP)

(21) Appl. No.: 12/057,187

(22) Filed: Mar. 27, 2008

(51) Int. Cl. C08L 79/06; C08G 73/08

(52) U.S. Cl. 525/417; 528/423; 528/210

(57) ABSTRACT

A diamine polymer comprising a repeat unit represented by the following formula (I) in which diamine is linked to form a triaza ring;

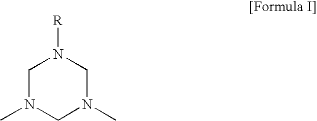

wherein R represents a monoamine residue.

### FIELD OF THE INVENTION

The present invention relates to a diamine polymer and a resin composition thereof, and more particularly, to a triaza ring-linked diamine polymer in which diamine is linked to form a triaza ring.

### DESCRIPTION OF THE RELATED ART

There have been traditionally known a number of methods for producing a polymer by linking diamine with another compound. Examples of such polymer include aliphatic polyamides in which aliphatic diamine is linked by aliphatic dicarboxylic acid (Nylon and the like), aromatic polyamides in which aromatic diamine is linked by aromatic dicarboxylic acid (Kevlar and the like), and polyimides in which aromatic diamine is linked by aromatic acid anhydride (Kapton and the like).

It has been known that a compound having a triaza ring is obtained by mixing diamine with formaldehyde. Furthermore, a compound having a triaza ring obtained by mixing an amine with formaldehyde is disclosed in Zdenka Brunovska, Macromol. Chem. Phys., Vol. 200, p. 1745-1752 (1999), but this compound is merely used as a starting material for synthesis of benzoxazine compounds.

Furthermore, when diamine is reacted with formaldehyde, typically many branches or a cross-linked structure is generated, and thus it has been conceived that a polymer having excellent moldability cannot be obtained Therefore, there was no example of investigating a polymer which is prepared using diamine, while being a moldable polymer having diamine linked to form a triaza ring.

### BRIEF SUMMARY OF THE INVENTION

Thus, in light of the above, an object of the present invention is to provide a diamine polymer which can be practically used.

The inventors of the present invention devotedly conducted research on the above-described problems, and as a result, found that when a mixture of diamine and monoamine at an appropriate ratio is reacted with formaldehyde, a diamine polymer having excellent solubility or thermoplasticity is obtained, thus completing the present invention.

That is, the present invention is as follows.

1. A diamine polymer comprising a repeat unit represented by the following formula (I) in which diamine is linked to form a triaza ring;

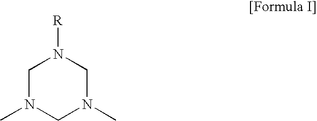

wherein R represents a monoamine residue.

2. The diamine polymer according to 1 above, wherein R is a hydroxyphenyl group.

3. A diamine polymer obtained by reacting a diamine and a monoamine with formaldehyde, and linked to form a triaza ring represented by the following formula (I):

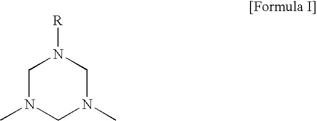

wherein R represents a monoamine residue.

4. The diamine polymer according to 3 above, wherein the molar ratio of diamine/monoamine is 1.0 or less.

5. The diamine polymer according to 3 above, wherein the monoamine is aminophenol.

6. The diamine polymer according to 4 above, wherein the monoamine is aminophenol.

7. A resin composition comprising the diamine polymer according to 1 above, and an epoxy resin.

8. A resin composition comprising the diamine polymer according to 3 above, and an epoxy resin.

The diamine polymer obtained by the present invention, in which diamine is linked to a triaza ring, has excellent solubility or thermoplasticity, thus being easily molded. Furthermore, when aminophenol is used as the monoamine, a phenolic hydroxyl group can be introduced into the diamine polymer molecule, and accordingly, it is also possible to generate a benzoxazine ring structure. In addition, a resin composition comprising the diamine polymer of the present invention and an epoxy resin is a resin composition having excellent curability, and resulting in excellent properties after curing. A molded product obtained by molding by heating the resin composition of the present invention has excellent heat resistance and mechanical strength, and thus can be suitably used in electric and electronic parts, automobile parts, copper clad laminate boards, printed boards, refractory coatings, matrix resin for composite materials, and the like.

### BRIEF DESCRIPTION OF THE DRAWINGS

FIG. 1 shows the proton nuclear magnetic resonance spectrum (¹H-NMR spectrum) of the diamine polymer of Example 1; and

FIG. 2 shows the Fourier transform infrared absorption spectrum (FT-IR spectrum) of the diamine polymer of Example 2.

### DESCRIPTION OF THE PREFERRED EMBODIMENTS

The diamine polymer of the present invention is a diamine polymer characterized in that the diamine polymer comprises a repeat unit represented by the following formula (I) in which diamine is linked to form a triaza ring;

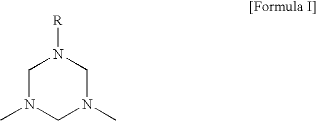

wherein R represents a monoamine residue.

Furthermore, the diamine polymer of the present invention is a diamine polymer produced by reacting a mixture of diamine and monoamine at an appropriate ratio, with formaldehyde.

In the above Formula (I), R represents a residual moiety of monoamine, and preferably represents a hydroxyphenyl group which is a residue of hydroxyaniline.

When the diamine polymer of the present invention is mixed with an epoxy resin, a resin composition having excellent curability and excellent properties after curing can be obtained.

Diamine Polymer

The diamine polymer of the present invention will be described in detail with reference to specific examples.

A diamine polymer produced using 4,4′-diaminodiphenyl ether as the diamine and using 4-aminophenol as the monoamine, to react them with formaldehyde, is represented in Scheme 1.

For the diamine polymer of the present invention, it will be explained that there are three types of triaza ring linking the diamine units as shown in scheme 1. That is, there are three types such as a triaza ring terminating the linkage of the diamine polymer (chain terminating type), a triaza ring linking the diamine polymer in a straight-chain form (chain extending type) and a triaza ring linking the diamine polymer in a branched form (chain branching type).

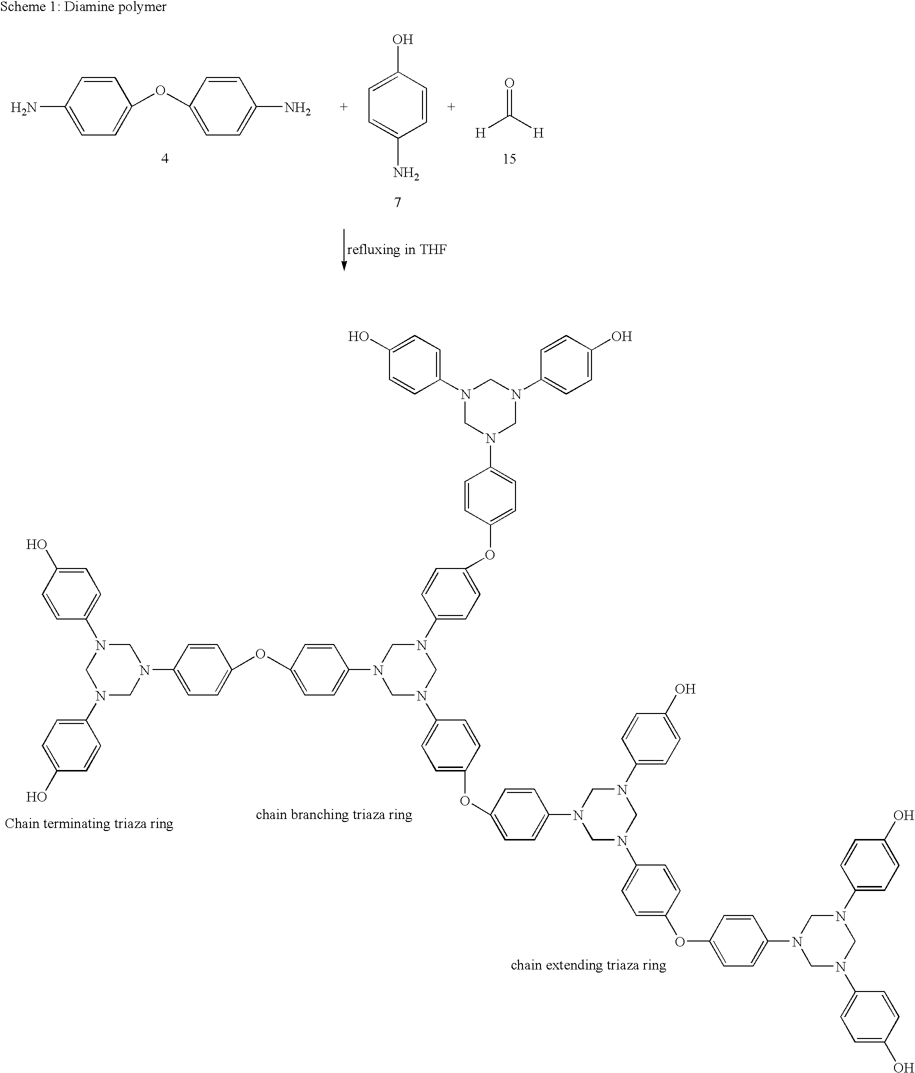

For the diamine polymer of the present invention, when the molar ratio of diamine/monoamine is smaller than 0.5, there will be too many of the triaza rings terminating the linkage of the diamine polymer. Thus, an extreme decrease is resulted in the molecular weight of the diamine polymer, and the mechanical strength of the resulting diamine polymer is impaired.

On the contrary, when the molar ratio of diamine/monoamine is larger than 1.0, there will be too many of the triaza rings linking the diamine polymer in the branching manner, and thus the resulting diamine polymer gelates and becomes insoluble.

Therefore, the molar ratio of diamine/monoamine is preferably 1.0 or less, more preferably 0.55 to 0.95, and even more preferably 0.60 to 0.80.

By performing polymerization while controlling the molar ratio of diamine/monoamine to be within the above-described range, the molecular weight of the resulting diamine polymer (even though would vary depending on the starting material used) can be controlled to be between about 1,000 and about 20,000.

Method for Producing Diamine Polymer

The diamine used in the present invention is not particularly limited, but for example, a commercially available diamine such as 4,4′-diaminodiphenylether, hexamethylenediamine, dianisidine, 4,4′-diamino-3,3′-diethyldiphenylmethane, 4,4′-diaminobenzanilide, 4,4′-diamino-3,3′-dimethyldiphenylmethane, 4,4′-diaminodiphenylmethane, m-toluylenediamine or m-phenylenediamine, can be used.

A diamine in which two molecules of diamine and one molecule of acid anhydride, for example, 3,3′-4,4′-benzophenonetetracarboxylic dianhydride is used to link diamine units with an imide bond, and to thus extend the diamine chain, can also be suitably used.

The monoamine used in the present invention is not particularly limited, but a known monoamine such as methylamine, propylamine or aniline can be used. Among them, it is most preferable to use aminophenol as the monoamine, because a phenolic hydroxyl group can be introduced into the molecule of diamine polymer.

Introduction of a phenolic hydroxyl group can impart polarity to the diamine polymer of the present invention, and increase the solubility. As described in the above-mentioned literature, it is also possible to generate a benzoxazine structure when heated, and then provide a strong cross-linked structure by a ring opening reaction of benzoxazine.

The formaldehyde used in the present invention is not particularly limited, but can be used in the form of paraformaldehyde which is a polymer, or in the form of formalin which takes an aqueous solution form.

The method for producing the diamine polymer of the present invention is not particularly limited, but basically, the diamine polymer can be produced by a method of mixing the three components of diamine, monoamine and formaldehyde, further adding a solvent, and heating the mixture while stirring.

The mixing ratio of diamine and monoamine is, as described in the above, preferably 1.0 or less, more preferably 0.55 to 0.95, and even more preferably 0.60 to 0.80, as a molar ratio of diamine/monoamine.

The mixing ratio of formaldehyde is not particularly limited, but it is preferable to incorporate formaldehyde in a mole number greater than or equal to the mole number of the amino functional group so as to coincide the mixing ratio with the stoichiometric ratio.

The solvent used in the present invention is not particularly limited as long as the solvent dissolves the starting material to some extent and does not inhibit the reaction for generating triaza rings, but for example, N-methylpyrrolidone, dimethylacetamide, dimethylsulfoxide, dimethylformamide, dioxane, tetrahydrofuran or the like can be used.

The reaction temperature and the reaction time are also not particularly limited, but the reaction may be carried out typically at a temperature of about 50° C. to 130° C. for 10 minutes to 1 hour.

A compound can be precipitated by adding the solution obtained after the reaction to, for example, a large amount of a poor solvent such as water, and when this precipitate is separated and dried, the desired diamine polymer can be obtained.

Method for Producing Resin Composition

The resin composition of the present invention can be produced by, for example, dissolving the diamine polymer (powdered) obtained as described above and an epoxy resin (typically, a liquid of high viscosity) in an appropriate solvent or the like, and then removing the solvent.

The method for removing the solvent is not particularly limited, but a method of naturally drying the solvent in a vessel with a large area, and then completely drying the residue in a vacuum oven, can be suitably used. Thereafter, the dried residue can be pulverized to obtain the resin composition of the present invention in a powdered state.

The mixing proportion of the diamine polymer and the epoxy resin is not particularly limited, but the mole number of triaza ring in the diamine polymer/the mole number of epoxy functional group in the epoxy resin is preferably 0.3 to 3.0, and more preferably 0.5 to 2.0.

If this ratio is too small, when the resin composition is cured, heat resistance or rigidity of the cured product may be impaired. Also, if the ratio is too large, when the resin composition is cured, the mechanical properties, and particularly elongation, of the cured product may be impaired.

Molding of Resin Composition

The method of molding the resin composition of the present invention is not particularly limited, and a molded product can be obtained by charging the resin composition into a desired mold, and heating the system at a temperature of 120 to 200° C. for 30 minutes to 2 hours.

Since the resin composition of the present invention has triaza rings in the structure, the triaza rings undergo ring opening when heated, and in the case where phenolic hydroxyl groups are present in the molecule, there occurs a cross-linking reaction via a benzoxazine structure. Also, a reaction with the epoxy resin in the composition also occurs, thereby a strong cured resin (molded product) being obtained.

The resin composition of the present invention can be easily subjected to molding such as film formation, and the resulting molded product has excellent heat resistance and mechanical strength. Therefore, the composition can be suitably used in electric and electronic parts, automobile parts, copper clad laminate boards printed boards, refractory coatings, matrix resins for composite materials, and the like.

### EXAMPLES

Hereinafter, the present invention will be described in more detail with reference to Examples, but the present invention is not intended to be limited to the Examples described below. In addition/ the term percent means percent by mass in the following.

[Measurement Methods]

The methods for measuring properties in the present specification are as follows.

(1) Proton Nuclear Magnetic Resonance Spectrum (¹H-NMR Spectrum)

¹H-NMR (600 MHz) manufactured by Varian Inova, Inc.

Deuterated dimethylsulfoxide was used, integration of 256 cycles, relation time of 10 seconds

(2) Fourier Transform Infrared Absorption Spectrum (FT-IR Spectrum)

Bomem Michelson MB100 FT-IR spectrometer, integration of 32 cycles in dry air, KBr pellets were used.

(3) Resistance to Thermal Degradation

The weight reduction was measured using a high resolution 2950 thermal gravimetric analyzer (TA Instrument, Inc.), at a rate of temperature elevation of 5° C./min, and the temperature at which 5% weight reduction occurs (Td5) was measured,

(4) Tensile Strength

Instron Universal Tester (Model 5565)

Sample specimen (Type V ASTM D6-38-03)

Measurement was conducted at a stretching rate of 1 mm/min.

### Example 1

(Production of Diamine Polymer)

To a round-bottom flask having a capacity of 300 cc equipped with a reflux unit, 20 g of 4,4′-diaminodiphenylmethane (Wako Pure Chemical Industries, Ltd.), 16.3 g of 4-aminophenol (Wako Pure Chemical Industries, Ltd.), 28 g of a 37% aqueous formaldehyde solution (Wako Pure Chemical Industries, Ltd.), and 300 g of tetrahydrofuran (Wako Pure Chemical Industries, Ltd.) were added, and the mixture was dissolved by heating in an oil bath set at 30° C. The temperature of the oil bath was elevated up to 90° C., and the reaction was continued for 30 minutes while refluxing the solvent. Then, the reaction solution was cooled to room temperature.

This solution was added dropwise to 2 liters of cold water under vigorously stirring Precipitated solids were filtered, and then washed with methanol. The resulting powder was dried in vacuum for 24 hours in a vacuum oven heated to 40° C.

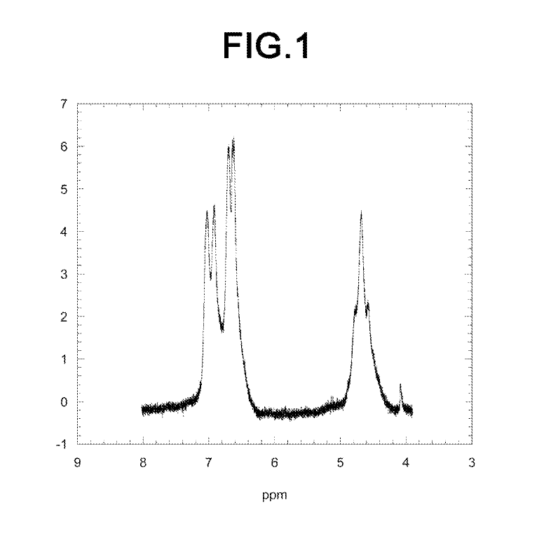

A ¹H-NMR spectrum of the obtained diamine polymer is shown in FIG. 1. Resonance absorption of the methylene group of a triaza ring is seen in the region of 4 to 5 ppm. Since the triaza rings in the diamine polymer constitute a mixture of three types, namely, the chain terminating type, the chain branching type and the chain extending type, as described above, the resonance peaks are also observed in broad forms.

(Production of Resin Composition)

10 g of the diamine polymer produced as described above, 10 g of Bis A glycidyl ether type epoxy resin (epoxy equivalent: 186, EPON828, Shell Chemicals, Ltd.). and 20 g of tetrahydrofuran were mixed to prepare a solution. This mixed solution was poured on a releasably treated flat vessel with a large area, and naturally dried at normal temperature for 24 hours. Subsequently, the residue was dried for another 24 hours in a vacuum oven set at 50° C., and then pulverized to produce a powdered resin composition.

(Production of Sheet)

The resin composition produced as described above was placed under a hot press releasably treated and controlled to a temperature of 150° C., and was subjected to curing by heating for 10 minutes without pressurizing. Then, the resultant was cooled. The resin composition was molded into a sheet having a thickness of 0.1 mm. The tensile strength and resistance to thermal degradation (temperature of 5% weight reduction) of this sheet were measured (Table 1).

### Example 2

(Synthesis of Diamine Polymer Having a Structure Represented by the Following Formula (II))

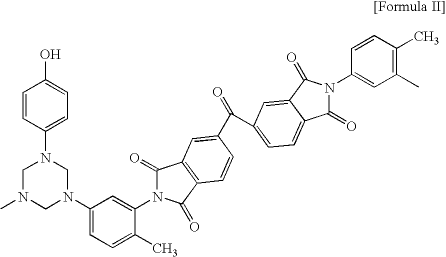

(Preparation of Imide Unit)

For the preparation of imide unit, dimethylformamide (hereinafter, referred to as DMF) which had been distilled and then dehydrated by adding a molecular sieve (4A), was used as a solvent.

To a round-bottom flask having a capacity of 300 cc, 3.7 g of 2,4-diaminotoluene (Wako Pure Chemical Industries, Ltd.), and 40 g of DMF (Wako Pure Chemical Industries, Ltd.) were added, and the mixture was dissolved by heating in an oil bath set at 160° C. Subsequently, 6.4 g (3,3′,4,4′-benzophenonetetracarboxylic dianhydride (Aldrich Chemical Company, Inc.) was poured at once into the flask, and the entire mixture was vigorously stirred. Then, 10 g of toluene (Wako Pure Chemical Industries, Ltd.) was added, and then the reaction was continued for 2 hours at 160° C., while removing the water generated during the reaction using a Dean-Stark type collector attached to the flask. Then, the reaction solution was cooled to room temperature.

This solution was added dropwise to 100 g of methanol under vigorously stirring. Precipitated solids were filtered, and then washed with methanol. The resulting powder was dried in vacuum for 24 hours in a vacuum oven heated to 40° C.

(Production of Diamine Polymer)

To a round-bottom flask having a capacity of 300 cc, 5 g of the imide unit prepared as described above, 0.5 g of 4-aminophenol, 1.2 g of a 37% aqueous formaldehyde solutions and 20 g of DMF were added, and the mixture was dissolved by heating in an oil bath set at 30° C. The temperature of the oil bath was elevated up to 90° C., and the reaction was continued for 30 minutes while refluxing the solvent. Then, the reaction solution was cooled to room temperature.

This solution was added dropwise to 2 liters of cold water under vigorously stirring. Precipitated solids were filtered, and then washed with methanol. The resulting powder was dried in vacuum for 24 hours in a vacuum oven heated to 40° C.

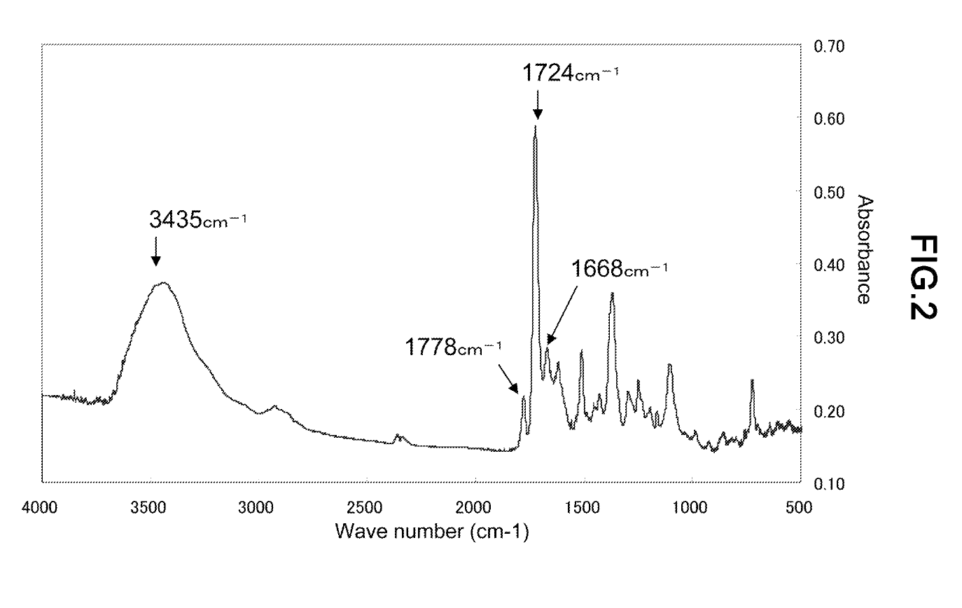

An FT-IR spectrum of the resulting diamine polymer is presented in FIG. 2. The assignment for the FT-IR spectrum is as follows.

Phenolic hydroxyl group: 3435 cm⁻¹

Imide functional group; 1779, 1724 cm⁻¹

Carbonyl functional group (benzophenone); 1668 cm⁻¹

(Production of Sheet)

The diamine polymer produced as described above was dissolved again in DMF to prepare a 10% solution. This solution was poured into a frame installed on a substrate made of Teflon, and in this state, the solvent was removed by evaporation (evaporation time: 60 minutes) in a hot air oven set at 120° C.

Subsequently, a curing reaction for the dried sheet was performed for 1 hour in an oven set at a temperature of 250° C., and then the system was cooled to obtain a sheet having a thickness of 0.1 mm. Tensile strength and resistance to thermal degradation (temperature of 5% weight reduction) of this sheet were measured (Table 1).

TABLE 1

| | Temperature of 5% | |
|---|---|---|
| | weight reduction | Tensile strength |
| Example 1 | 310° C. | 85 MPa |
| Example 2 | 480° C. | 90 MPa |

As can be seen from the results of Example 1, the resin composition of the present invention can yield a cured product having excellent heat resistance and tensile strength, even by curing at a relatively low temperature (150° C.) for a short time.

As can be seen from the results of Example 2, the diamine polymer of the present invention has good solubility, even though the polymer has an imide structure with poor solubility in the molecule. The cast cured sheet obtained therefrom has excellent heat resistance and tensile strength.

What is claimed is:

1. A diamine polymer comprising a repeat unit represented by the following formula (I) in which diamine is linked to form a triaza ring; 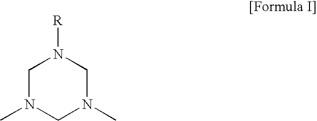
wherein R represents a monoamine residue.

2. The diamine polymer according to claim 1, wherein R is a hydroxyphenyl group.

3. A diamine polymer obtained by reacting a diamine and a monoamine with formaldehyde, and linked to form a triaza ring represented by the following formula (I): 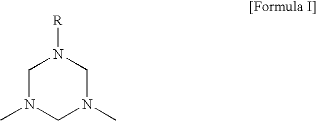
wherein R represents a monoamine residue.

4. The diamine polymer according to claim 3, wherein the molar ratio of diamine/monoamine is 1.0 or less.

5. The diamine polymer according to claim 3, wherein the monoamine is aminiophenol.

6. The diamine polymer according to claim 4, wherein the monoamine is aminiophenol.

7. A resin composition comprising the diamine polymer according to claim 1, and an epoxy resin.

8. A resin composition comprising the diamine polymer according to claim 3, and an epoxy resin.
